(19) United States
(12) Patent Application Publication
(10) Pub. No.: US 2007/0048621 A1
(43) Pub. Date: Mar. 1, 2007

(54) Non-aqueous electrolytic solution, secondary battery, and electrochemical capacitor

(75) Inventors: Meguru Kashida, Annaka-shi (JP); Tetsuo Nakanishi, Annaka-shi (JP); Satoru Miyawaki, Annaka-shi (JP); Mikio Aramata, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/507,543

(22) Filed: Aug. 22, 2006

(30) Foreign Application Priority Data
Aug. 25, 2005 (JP) 2005-244088

(51) Int. Cl. H01M 10/40

(52) U.S. Cl. 429/326

(57) ABSTRACT

A polyoxyalkylene-modified silane is combined with a non-aqueous solvent and an electrolyte salt to form a non-aqueous electrolytic solution, which is used to construct a secondary battery having improved temperature and high-output characteristics.

### CROSS-REFERENCE TO RELATED APPLICATION

This non-provisional application claims priority under 35 U.S.C. §119(a) on patent application Ser. No. 2005-244088 filed in Japan on Aug. 25, 2005, the entire contents of which are hereby incorporated by reference.

### TECHNICAL FIELD

This invention relates to a non-aqueous electrolytic solution comprising a polyoxyalkylene-modified silane. It also relates to energy devices using the same, specifically secondary batteries and electrochemical capacitors, and especially lithium ion secondary batteries.

### BACKGROUND ART

Because of their high energy density, lithium ion secondary batteries are increasingly used in recent years as portable rechargeable power sources for laptop computers, mobile phones, digital cameras, digital video cameras, and the like. Also great efforts are devoted to the development of lithium ion secondary batteries and electric double-layer capacitors using non-aqueous electrolytic solution, as auxiliary power sources for electric and hybrid automobiles which are desired to reach a practically acceptable level as environment-friendly automobiles.

The lithium ion secondary batteries, albeit their high performance, are not satisfactory with respect to discharge characteristics in a rigorous environment, especially low-temperature environment, and discharge characteristics at high output levels requiring a large quantity of electricity within a short duration of time. On the other hand, the electric double-layer capacitors suffer from problems including insufficient withstand voltages and a decline with time of their electric capacity. Most batteries use non-aqueous electrolytic solutions based on low-flash-point solvents, typically dimethyl carbonate and diethyl carbonate. In case of thermal runaway in the battery, the electrolytic solution will vaporize and be decomposed, imposing the risk of battery rupture and ignition. Then, IC circuits are generally incorporated in the batteries as means for breaking currents under abnormal conditions, and safety valves are also incorporated for avoiding any rise of the battery internal pressure by the evolution of hydrocarbon gases. It is thus desired to further elaborate the electrolytic solutions for the purposes of safety improvement, weight reduction, and cost reduction.

Reference should be made to JP-A 11-214032, JP-A 2000-58123 both corresponding to U.S. Pat. No. 6,124,062, JP-A 2001-110455, and JP-A 2003-142157.

### SUMMARY OF THE INVENTION

An object of the present invention is to provide a non-aqueous electrolytic solution which enables construction of a battery, especially a non-aqueous electrolyte secondary battery, having improved discharge characteristics both at low temperatures and at high outputs as well as improved safety. Another object is to provide energy storage devices using the same, specifically secondary batteries and electrochemical capacitors, more specifically non-aqueous electrolyte secondary batteries and electric double-layer capacitors.

### DISCLOSURE OF THE INVENTION

The inventors have discovered that a non-aqueous electrolytic solution comprising a specific polyoxyalkylene-modified silane offers improved charge/discharge cycle performance over non-aqueous electrolytic solutions comprising conventional polyether-modified siloxanes.

The present invention provides a non-aqueous electrolytic solution comprising a non-aqueous solvent, an electrolyte salt, and a polyoxyalkylene-modified silane having the formula (1) as essential components.
R¹₍₄₋ₓ₎—Si-Aₓ (1)
Herein R¹ is each independently an organic radical selected from among alkyl, aryl, aralkyl, amino-substituted alkyl, carboxyl-substituted alkyl, alkoxy, and aryloxy radicals of 1 to 30 carbon atoms which may be partially substituted with halogen atoms, x is an integer of 1 to 4, and A is a polyoxyalkylene radical of the formula (2):
—R²O—(CₐH₂ₐO)_{b}—R³ (2)
wherein R² is a divalent organic radical of 2 to 20 carbon atoms which may contain an ether or ester bond, a is an integer of 2 to 4, b is an integer of 1 to 6, and R³ is selected from among alkyl, aryl, aralkyl, amino-substituted alkyl, and carboxyl-substituted alkyl radicals of 1 to 30 carbon atoms which may be substituted with halogen atoms.

The present invention also provides a secondary battery, electrochemical capacitor, and lithium ion secondary battery comprising the non-aqueous electrolytic solution defined above. In the lithium ion secondary battery comprising a positive electrode, a negative electrode, a separator, and the non-aqueous electrolytic solution of the invention, charging/discharging operation occurs through migration of lithium ions between positive and negative electrodes.

### BENEFITS OF THE INVENTION

Energy storage devices using the non-aqueous electrolytic solution comprising a polyoxyalkylene-modified silane according to the invention exhibit improved temperature and high-output characteristics.

### DESCRIPTION OF THE PREFERRED EMBODIMENTS

The non-aqueous electrolytic solution of the invention contains a polyoxyalkylene-modified silane having the formula (1).
R¹₍₄₋ₓ₎—Si-Aₓ (1)
Herein R¹ may be the same or different and is an organic radical selected from among alkyl, aryl, aralkyl, amino-substituted alkyl, carboxyl-substituted alkyl, alkoxy, and aryloxy radicals of 1 to 30 carbon atoms, preferably 1 to 12 carbon atoms, more preferably 1 to 6 carbon atoms, which may be partially substituted with halogen atoms. Examples include, but are not limited to, alkyl radicals such as methyl, ethyl, propyl, butyl, pentyl, cyclopentyl, hexyl, cyclohexyl, heptyl, octyl, nonyl, and decyl; aryl radicals such as phenyl and tolyl; aralkyl radicals such as benzyl and phenethyl; amino-substituted alkyl radicals such as 3-aminopropyl and 3-[(2-aminoethyl)amino]propyl; and carboxy-substituted alkyl radicals such as 3-carboxypropyl. Also included are halogenated alkyl radicals in which some hydrogen atoms are substituted by halogen atoms, typically fluorine atoms, such as trifluoropropyl and nonafluorooctyl. Suitable alkoxy radicals include methoxy, ethoxy, propoxy, and isopropoxy. A typical aryloxy radical is phenoxy. Of these, alkyl and fluoroalkyl radicals of 1 to 6 carbon atoms are preferred. Methyl and ethyl are most preferred. It is especially preferred that at least 80 mol % of R¹ be methyl or ethyl.

“A” is a polyoxyalkylene radical of the formula (2).
—R²O—(CₐH₂ₐO)_{b}—R³ (2)
Herein R² is selected from divalent organic radicals of 2 to 20 carbon atoms, preferably 2 to 10 carbon atoms, typically straight or branched alkylene radicals, which may contain an ether bond (—O—) or ester bond (—COO—). Suitable organic radicals include —(CH₂)₂—, —(CH₂)₃—, —(CH₂)₄—, —CH₂CH(CH₃)CH₂—, —(CH₂)₅—, —(CH₂)₆—, —(CH₂)₇—, —(CH₂)₈—, —(CH₂)₂—CH(CH₂CH₂CH₃)—, —CH₂—CH(CH₂CH₃)—, —(CH₂)₃—O—CH₂—, —(CH₂)₃—O—(CH₂)₂—, —(CH₂)₃—O—(CH₂)₂—O—(CH₂)₂—, —(CH₂)₃—O—CH₂CH(CH₃)—, and —CH₂—CH(CH₃)—COO(CH₂)₂—. Also included are substituted forms of the foregoing in which some or all hydrogen atoms are substituted by fluorine atoms, such as perfluoroether radicals. Of these, trimethylene, —CH₂CH(CH₃)CH₂— and —(CH₂)₃—O—CH₂— are most preferred.

R³ is selected from among alkyl, aryl, aralkyl, amino-substituted alkyl, and carboxyl-substituted alkyl radicals of 1 to 30 carbon atoms, preferably 1 to 12 carbon atoms, more preferably 1 to 6 carbon atoms, which may be substituted with halogen atoms. Examples include, but are not limited to, alkyl radicals such as methyl, ethyl, propyl, butyl, pentyl, cyclopentyl, hexyl, cyclohexyl, heptyl, octyl, nonyl, and decyl; aryl radicals such as phenyl and tolyl; aralkyl radicals such as benzyl and phenethyl; amino-substituted alkyl radicals such as 3-aminopropyl and 3-[(2-aminoethyl)amino]propyl; and carboxy-substituted alkyl radicals such as 3-carboxypropyl. Also included are halogenated alkyl radicals in which some hydrogen atoms are substituted by halogen atoms, typically fluorine atoms, such as trifluoropropyl and nonafluorooctyl. Of these, alkyl and fluoroalkyl radicals of 1 to 6 carbon atoms are preferred. Methyl and ethyl are most preferred.

In formula (1), x is an integer of 1 to 4. It is preferred that x be equal to 1 or 2, and especially equal to 1, because if x is 3 or 4, the polyoxyalkylene radical content is relatively increased to detract from silicon characteristics.

The subscript a is an integer of 2 to 4, preferably equal to 2 or 3, and b is an integer of 1 to 6, preferably an integer of 2 to 4. If a is more than 4 or if b is more than 6, then the polyoxyalkylene-modified siloxane may have a viscosity high enough to reduce the ion mobility in the electrolytic solution.

Illustrative examples of the polyoxyalkylene-modified silanes (1) include compounds [I] through [XIII] shown below.

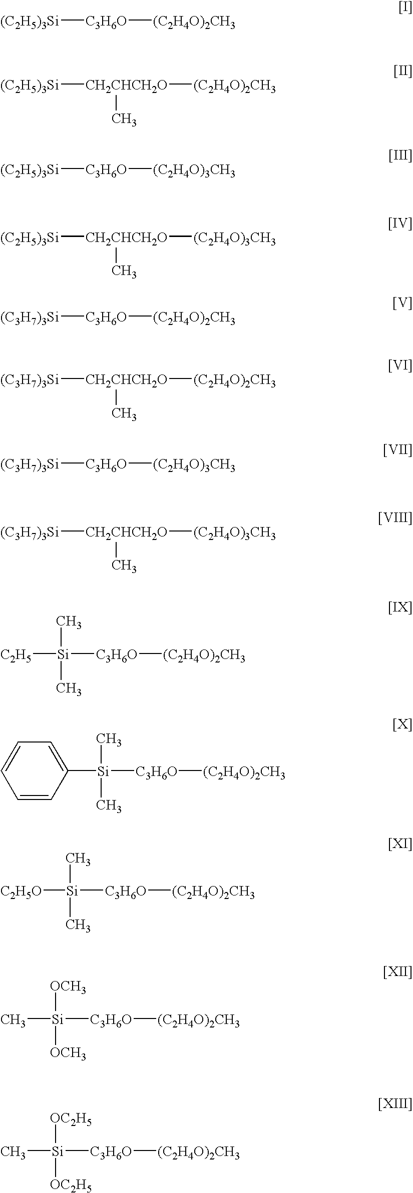

The polyoxyalkylene-modified silane (1) may be obtained through addition reaction of a silane having a silicon-bonded hydrogen atom (i.e., SiH radical) with a polyoxyalkylene having a carbon-to-carbon double bond. For example, compound [I] of the formula:
(C₂H₅)₃Si—C₃H₆O—(C₂H₄O)₂CH₃ [I]
may be obtained through addition reaction of triethylsilane with CH₂═CHCH₂(C₂H₄O)₂CH₃.

Desirably the addition reaction is effected in the presence of a platinum or rhodium catalyst. Suitable catalysts used herein include chloroplatinic acid, alcohol-modified chloroplatinic acid, and chloroplatinic acid-vinyl siloxane complexes. Further sodium acetate or sodium citrate may be added as a co-catalyst or pH buffer. The catalyst is used in a catalytic amount, and preferably such that platinum or rhodium is present in an amount of up to 50 ppm, more preferably up to 20 ppm, relative to the total weight of the siloxane having a SiH radical and the polyoxyalkylene having a carbon-to-carbon double bond.

If desired, the addition reaction may be effected in an organic solvent. Suitable organic solvents include aliphatic alcohols such as methanol, ethanol, 2-propanol and butanol; aromatic hydrocarbons such as toluene and xylene; aliphatic or alicyclic hydrocarbons such as n-pentane, n-hexane, and cyclohexane; and halogenated hydrocarbons such as dichloromethane, chloroform and carbon tetrachloride.

Addition reaction conditions are not particularly limited. Typically addition reaction is effected under reflux for about 1 to 10 hours.

In the non-aqueous electrolytic solution, the polyoxyalkylene-modified silane should preferably be present in an amount of at least 0.001% by volume. If the content of polyoxyalkylene-modified silane is less than 0.001% by volume, the desired effect may not be exerted. The preferred content is at least 0.1% by volume. The upper limit of the content varies with a particular type of solvent used in the non-aqueous electrolytic solution, but should be determined such that migration of Li ions within the non-aqueous electrolytic solution is at or above the practically acceptable level. The content is usually up to 80% by volume, preferably up to 60% by volume, and more preferably up to 50% by volume of the non-aqueous electrolytic solution. Meanwhile, it is acceptable that the silane content in the non-aqueous electrolytic solution be 100% by volume with any volatile solvent commonly used in non-aqueous electrolytic solutions of this type being omitted.

No particular limit is imposed on the viscosity of the polyoxyalkylene-modified silane. For smooth migration of Li ions within the non-aqueous electrolytic solution, the compound should preferably have a viscosity of up to 2,000 mm²/s, more preferably up to 1,000 mm²/S, as measured at 25° C. by a Cannon-Fenske viscometer.

The non-aqueous electrolytic solution of the invention further contains an electrolyte salt and a non-aqueous solvent. Exemplary of the electrolyte salt used herein are light metal salts. Examples of the light metal salts include salts of alkali metals such as lithium, sodium and potassium, salts of alkaline earth metals such as magnesium and calcium, and aluminum salts. A choice may be made among these salts and mixtures thereof depending on a particular purpose. Examples of suitable lithium salts include LiBF₄, LiClO₄, LiPF₆, LiAsF₆, CF₃SO₃Li, (CF₃SO₂)₂NLi, C₄F₉SO₃Li, CF₃CO₂Li, (CF₃CO₂)₂NLi, C₆F₅SO₃Li, C₈,F₁₇SO₃Li, (C₂F₅SO₂)₂NLi, (C₄F₉SO₂)(CF₃SO₂)NLi, (FSO₂C₆F₄)(CF₃SO₂)NLi, ((CF₃)₂CHOSO₂)₂NLi, (CF₃SO₂)₃CLi, (3,5-(CF₃)₂C₆F₃)₄BLi, LiCF₃, LiAlCl₄, and C₄BO₈Li, which may be used alone or in admixture.

From the electric conductivity aspect, the electrolyte salt is preferably present in a concentration of 0.5 to 2.0 mole/liter of the non-aqueous electrolytic solution. The electrolytic solution should preferably have a conductivity of at least 0.01 S/m at a temperature of 25° C., which may be adjusted in terms of the type and concentration of the electrolyte salt.

The non-aqueous solvent used herein is not particularly limited as long as it can serve for the non-aqueous electrolytic solution. Suitable solvents include aprotic high-dielectric-constant solvents such as ethylene carbonate, propylene carbonate, butylene carbonate, and y-butyrolactone; and aprotic low-viscosity solvents such as dimethyl carbonate, ethyl methyl carbonate, diethyl carbonate, methyl propyl carbonate, dipropyl carbonate, diethyl ether, tetrahydrofuran, 1,2-dimethoxyethane, 1,2-diethoxyethane, 1,3-dioxolane, sulfolane, methylsulfolane, acetonitrile, propionitrile, anisole, acetic acid esters, e.g., methyl acetate and propionic acid esters. It is desirable to use a mixture of an aprotic high-dielectric-constant solvent and an aprotic low-viscosity solvent in a proper ratio. It is also acceptable to use ionic liquids containing imidazolium, ammonium and pyridinium cations. The counter anions are not particularly limited and include BF₄⁻, PF₆⁻ and (CF₃SO₂)₂N⁻. The ionic liquid may be used in admixture with the foregoing non-aqueous solvent.

Where a solid electrolyte or gel electrolyte is desired, a silicone gel, silicone polyether gel, acrylic gel, acrylonitrile gel, poly(vinylidene fluoride) or the like may be included in a polymer form. These ingredients may be polymerized prior to or after casting. They may be used alone or in admixture.

If desired, various additives may be added to the non-aqueous electrolytic solution of the invention. Examples include an additive for improving cycle life such as vinylene carbonate, methyl vinylene carbonate, ethyl vinylene carbonate and 4-vinylethylene carbonate, an additive for preventing over-charging such as biphenyl, alkylbiphenyl, cyclohexylbenzene, t-butylbenzene, diphenyl ether, and benzofuran, and various carbonate compounds, carboxylic acid anhydrides, nitrogen- and sulfur-containing compounds for acid removal and water removal purposes.

A further embodiment of the present invention relates to electricity storage devices, such as secondary batteries and electrochemical capacitors, comprising a positive electrode, a negative electrode, a separator, and an electrolytic solution, wherein the non-aqueous electrolytic solution described above is used as the electrolytic solution.

The positive electrode active materials include oxides and sulfides which are capable of occluding and releasing lithium ions. They may be used alone or in admixture. Examples include sulfides and oxides of metals excluding lithium such as TiS₂, MoS₂, NbS₂, ZrS₂, VS₂, V₂O₅, MoO₃, Mg(V₃O₈)₂, and lithium and lithium-containing complex oxides. Composite metals such as NbSe₂ are also useful. For increasing the energy density, lithium complex oxides based on LiₚMetO₂ are preferred wherein Met is preferably at least one element of cobalt, nickel, iron and manganese and p has a value in the range: 0.05≦p≦1.10. Illustrative examples of the lithium complex oxides include LiCoO₂, LiNiO₂, LiFeO₂, and Li_{q}NiᵣCo₁₋ᵣO₂ (wherein q and r have values varying with the charged/discharged state of the battery and usually in the range: 0<q<1 and 0.7<r≦1) having a layer structure, LiMn₂O₄ having a spinel structure, and rhombic LiMnO₂. Also used is a substitutional spinel type manganese compound adapted for high voltage operation which is LiMetₛMn₁₋ₛO₄ wherein Met is titanium, chromium, iron, cobalt, nickel, copper, zinc or the like and s has a value in the range: 0<s<1.

It is noted that the lithium complex oxide described above is prepared, for example, by grinding and mixing a carbonate, nitrate, oxide or hydroxide of lithium and a carbonate, nitrate, oxide or hydroxide of a transition metal in accordance with the desired composition, and firing at a temperature in the range of 600 to 1,000° C. in an oxygen atmosphere.

Organic materials may also be used as the positive electrode active material. Examples include polyacetylene, polypyrrole, poly-p-phenylene, polyaniline, polythiophene, polyacene, and polysulfide.

The negative electrode materials capable of occluding and releasing lithium ions include carbonaceous materials, metal elements and analogous metal elements, metal complex oxides, and polymers such as polyacetylene and polypyrrole.

Suitable carbonaceous materials are classified in terms of carbonization process, and include carbon species and synthetic graphite species synthesized by the gas phase process such as acetylene black, pyrolytic carbon and natural graphite; carbon species synthesized by the liquid phase process including cokes such as petroleum coke and pitch coke; pyrolytic carbons obtained by firing polymers, wooden materials, phenolic resins, and carbon films; and carbon species synthesized by the solid phase process such as charcoal, vitreous carbons, and carbon fibers.

Also included in the negative electrode materials capable of occluding and releasing lithium ions are metal elements and analogous metal elements capable of forming alloys with lithium, in the form of elements, alloys or compounds. Their state includes a solid solution, eutectic, and intermetallic compound, with two or more states being optionally co-present. They may be used alone or in admixture of two or more.

Examples of suitable metal elements and analogous metal elements include tin, lead, aluminum, indium, silicon, zinc, copper, cobalt, antimony, bismuth, cadmium, magnesium, boron, gallium, germanium, arsenic, selenium, tellurium, silver, hafnium, zirconium and yttrium. Inter alia, Group 4B metal elements in element, alloy or compound form are preferred. More preferred are silicon and tin or alloys or compounds thereof. They may be crystalline or amorphous.

Illustrative examples of such alloys and compounds include LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, composite Si/SiC, Si₃N₄, Si₂N₂O, SiOᵥ (wherein 0<v≦2), composite SiO/C, SnO_{w} (wherein 0<w≦2), SnSiO₃, LiSiO and LiSnO.

Any desired method may be used in the preparation of positive and negative electrodes. Electrodes are generally prepared by adding an active material, binder, conductive agent and the like to a solvent to form a slurry, applying the slurry to a current collector sheet, drying and press bonding. The binder used herein is usually selected from polyvinylidene fluoride, polytetrafluoroethylene, styrene-butadiene rubber, isoprene rubber, and various polyimide resins. The conductive agent used herein is lo usually selected from carbonaceous materials such as graphite and carbon black, and metal materials such as copper and nickel. As the current collector, aluminum and aluminum alloys are usually employed for the positive electrode, and metals such as copper, stainless steel and nickel and alloys thereof employed for the negative electrode.

The separator disposed between the positive and negative electrodes is not particularly limited as long as it is stable to the electrolytic solution and holds the solution effectively. The separator is most often a porous sheet or non-woven fabric of polyolefins such as polyethylene and polypropylene. Porous glass and ceramics are employed as well.

The secondary battery may take any desired shape. In general, the battery is of the coin type wherein electrodes and a separator, all punched into coin shape, are stacked, or of the cylinder type wherein electrode sheets and a separator are spirally wound.

The non-aqueous electrolytic solution of the invention is also applicable to electrochemical capacitors comprising electrodes, a separator, and an electrolytic solution, especially electric double-layer capacitors or pseudo-electric double-layer capacitors, asymmetrical capacitors, and redox capacitors.

At least one of the electrodes in the capacitors is a polarizable electrode composed mainly of a carbonaceous material. The polarizable electrode is generally formed of a carbonaceous material, a conductive agent, and a binder. The polarizable electrode is prepared according to the same formulation as used for the lithium secondary battery. For example, it is prepared by mixing a powder or fibrous activated carbon with the conductive agent such as carbon black or acetylene black, adding polytetrafluoroethylene as the binder, and applying or pressing the mixture to a current collector of stainless steel or aluminum. Similarly, the separator and the electrolytic solution favor highly ion permeable materials, and the materials used in the lithium secondary battery can be used substantially in the same manner. The shape may be coin, cylindrical or rectangular.

### EXAMPLE

Examples of the present invention are given below for further illustrating the invention, but they are not to be construed as limiting the invention thereto. The viscosity is measured at 25° C. by a Cannon-Fenske viscometer.

### Examples 1-13 and Comparative Example 1

Synthesis of Polyoxyalkylene-modified Silane

A polyoxyalkylene-modified silane having the following formula, referred to as compound [I], was synthesized as follows.
(C₂H₅)₃Si—C₃H₆O—(C₂H₄O)₂CH₃ [I]

A reactor equipped with a stirrer, thermometer and reflux condenser was charged with 100 g of polyoxyethylene CH₂═CHCH₂(C₂H₄O)₂CH₃, 100 g of toluene, and 0.03 g of 0.5 wt % chloroplatinic acid in isopropyl alcohol. With stirring at 90° C., 73 g of triethylsilane was added dropwise to the mixture. Reaction took place while the molar ratio of terminal unsaturated radicals to SiH radicals was about 1.0. The reaction solution was precision distilled in vacuum, obtaining the target polyoxyalkylene-modified silane of the above formula. It had a viscosity of 3.5 mm²/s and a purity of 99.6% as analyzed by gas chromatography.

Preparation of Non-aqueous Electrolytic Solution Non-aqueous electrolytic solutions were prepared by dissolving the polyoxyethylene-modified silane [I] to [V], [IX], [XI] or [XIII] in a mixture of ethylene carbonate (EC) and diethyl carbonate (DEC) in the proportion shown in Table 1 and further dissolving LiPF₆ therein in a concentration of 1 mole/liter. For comparison purposes, a non-aqueous electrolytic solution was similarly prepared without using the polyoxyethylene-modified silane.

TABLE 1

| | | | Polyoxyethylene-modified silane | | |
|---|---|---|---|---|---|
| | EC | DEC | Chemical | Viscosity | |
| | (vol %) | (vol %) | structure | (mm²/s) | Vol % |
| Example 1 | 47.5 | 47.5 | Compound [I] | 3.5 | 5 |
| Example 2 | 45.0 | 45.0 | Compound [I] | 3.5 | 10 |
| Example 3 | 40.0 | 40.0 | Compound [I] | 3.5 | 20 |
| Example 4 | 47.5 | 47.5 | Compound [II] | 3.8 | 5 |
| Example 5 | 45.0 | 45.0 | Compound [II] | 3.8 | 10 |
| Example 6 | 47.5 | 47.5 | Compound [III] | 5.2 | 5 |
| Example 7 | 45.0 | 45.0 | Compound [III] | 5.2 | 10 |
| Example 8 | 47.5 | 47.5 | Compound [IV] | 5.6 | 5 |
| Example 9 | 45.0 | 45.0 | Compound [IV] | 5.6 | 10 |
| Example 10 | 47.5 | 47.5 | Compound [V] | 7.4 | 5 |
| Example 11 | 47.5 | 47.5 | Compound [IX] | 6.0 | 5 |
| Example 12 | 47.5 | 47.5 | Compound [XI] | 6.6 | 5 |
| Example 13 | 47.5 | 47.5 | Compound [XII] | 6.1 | 5 |
| Comparative | 50.0 | 50.0 | none | — | — |
| Example 1 | | | | | |

Preparation of Battery Materials

The positive electrode material used was a single layer sheet using LiCoO₂ as the active material and an aluminum foil as the current collector (trade name Pioxcel C-100 by Pionics Co., Ltd.). The negative electrode material used was a single layer sheet using graphite as the active material and a copper foil as the current collector (trade name Pioxcel A-100 by Pionics Co., Ltd.). The separator used was a glass fiber filter (trade name GC50 by Advantec Co., Ltd.).

Battery Assembly

A battery of 2032 coin type was assembled in a dry box blanketed with argon, using the foregoing battery materials, a stainless steel can housing also serving as a positive electrode conductor, a stainless steel sealing plate also serving as a negative electrode conductor, and an insulating gasket.

Battery Test (Low-temperature Characteristics)

The steps of charging (up to 4.2 volts with a constant current flow of 0.6 mA) and discharging (down to 2.5 volts with a constant current flow of 0.6 mA) at 25° C. were repeated 10 cycles, after which similar charging/discharging steps were repeated at 5° C. Provided that the discharge capacity at the 10th cycle at 25° C. is 100, the number of cycles repeated until the discharge capacity at 5° C. lowered to 80 was counted. The results are shown in Table 2.

Battery Test (High-output Characteristics)

The steps of charging (up to 4.2 volts with a constant current flow of 0.6 mA) and discharging (down to 2.5 volts with a constant current flow of 0.6 mA) at 25° C. were repeated 5 cycles, after which similar charging/discharging steps in which the charging conditions were kept unchanged, but the discharging current flow was increased to 5 mA were repeated 5 cycles. These two types of charging/discharging operation were alternately repeated. Provided that the discharge capacity at the 5th cycle in the initial 0.6 mA charge/discharge operation is 100, the number of cycles repeated until the discharge capacity lowered to 80 was 5 counted. The results are also shown in Table 2.

TABLE 2

| | Low-temperature test | High-output test |
|---|---|---|
| | (cycles) | (cycles) |
| Example 1 | 165 | 182 |
| Example 2 | 173 | 186 |
| Example 3 | 164 | 177 |
| Example 4 | 170 | 194 |
| Example 5 | 188 | 216 |
| Example 6 | 169 | 180 |
| Example 7 | 155 | 167 |
| Example 8 | 161 | 196 |
| Example 9 | 168 | 183 |
| Example 10 | 158 | 170 |
| Example 11 | 177 | 181 |
| Example 12 | 163 | 177 |
| Example 13 | 159 | 164 |
| Comparative Example 1 | 92 | 101 |

As seen from Table 2, Examples of the invention where polyoxyalkylene-modified silanes are added demonstrate excellent temperature and high-output characteristics as compared with Comparative Example 1 where no silanes are added.

Japanese Patent Application No. 2005-244088 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A non-aqueous electrolytic solution comprising a non-aqueous solvent, an electrolyte salt, and a polyoxyalkylene-modified silane having the formula (1):
R¹₍₄₋ₓ₎—Si-A_{X} (1)
wherein R¹ is each independently an organic radical selected from the group consisting of alkyl, aryl, aralkyl, amino-substituted alkyl, carboxyl-substituted alkyl, alkoxy, and aryloxy radicals of 1 to 30 carbon atoms which may be partially substituted with halogen atoms, x is an integer of 1 to 4, and A is a polyoxyalkylene radical of the formula (2):
—R²O—(CₐH₂ₐO)_{b}—R³ (2)
wherein R² is a divalent organic radical of 2 to 20 carbon atoms which may contain an ether or ester bond, a is an integer of 2 to 4, b is an integer of 1 to 6, and R³ is selected from the group consisting of alkyl, aryl, aralkyl, amino-substituted alkyl, and carboxyl-substituted alkyl radicals of 1 to 30 carbon atoms which may be substituted with halogen atoms.

2. The non-aqueous electrolytic solution of claim 1 wherein R¹ in formula (1) is an alkyl or fluoroalkyl radical of 1 to 6 carbon atoms.

3. The non-aqueous electrolytic solution of claim 1 wherein R² in formula (2) is —(CH₂)₃—.

4. The non-aqueous electrolytic solution of claim 1 wherein R² in formula (2) is —CH₂CH(CH₃)CH₂—.

5. The non-aqueous electrolytic solution of claim 1 wherein R² in formula (2) is —(CH₂)₃—O—CH₂—.

6. The non-aqueous electrolytic solution of claim 1 wherein the polyoxyalkylene-modified silane is present in an amount of at least 0.001% by volume of the entire non-aqueous electrolytic solution.

7. The non-aqueous electrolytic solution of claim 1 wherein the electrolyte salt is a lithium salt.

8. A secondary battery comprising the non-aqueous electrolytic solution of claim 1.

9. An electrochemical capacitor comprising the non-aqueous electrolytic solution of claim 1.

10. A lithium ion secondary battery comprising the non-aqueous electrolytic solution of claim 1.
